(19) United States
(12) Patent Application Publication
(10) Pub. No.: US 2024/0396486 A1
(43) Pub. Date: Nov. 28, 2024

(54) POWER CONVERSION APPARATUS, MOTOR DRIVE APPARATUS, AND REFRIGERATION CYCLE APPLICATION APPARATUS

(71) Applicant: Mitsubishi Electric Corporation, Tokyo (JP)

(72) Inventors: Shinya TOYODOME, Tokyo (JP); Kazunori HATAKEYAMA, Tokyo (JP); Shoei TSUTSUMI, Tokyo (JP)

(21) Appl. No.: 18/695,130

(22) PCT Filed: Nov. 26, 2021
(86) PCT No.: PCT/JP2021/043479

§ 371 Date: Mar. 25, 2024

(51) Int. Cl. H02P 27/08; H02P 23/04

(52) U.S. Cl. CPC H02P 27/08; H02P 23/04; F25B 2600/021

(57) ABSTRACT

A power conversion apparatus includes a converter that rectifies a power-supply voltage applied from an AC power supply, a capacitor connected to an output end of the converter, an inverter connected across the capacitor, and a control device that controls an operation of the inverter. The control device performs a first control of reducing a pulsatile component of a capacitor output current output from the capacitor to the inverter when the load is driven. The first control is control of causing the motor to generate a loss, and the loss that the motor is caused to generate is performed by using a y-axis current.

### FIELD

The present disclosure relates to a power conversion apparatus for supplying AC power to a motor that drives a load, to a motor drive apparatus, and to a refrigeration cycle application apparatus.

### BACKGROUND

A power conversion apparatus includes: a converter that rectifies a power-supply voltage applied from an AC power supply; a capacitor connected to an output end of the converter; and an inverter that converts a DC voltage output from the capacitor into an AC voltage and applies the AC voltage to the motor.

Patent Literature 1 below discloses a technique for preventing an increase in power consumption by appropriately compensating for torque pulsation, which is a pulsatile component of load torque, in accordance with a state of a motor that drives a compressor.

### CITATION LIST

### Patent Literature

Patent Literature 1: Japanese Patent Application Laid-open No. 2016-178814

### SUMMARY OF INVENTION

### Problem to be Solved by the Invention

In an air conditioner which is one of application products of a refrigeration cycle application apparatus, in order to prevent a failure due to a harmonic component included in a power-supply current, a regulation regarding harmonics of the power-supply current is defined. For example, in Japan, a limit value is defined for harmonics of a power-supply current by Japanese Industrial Standard (JIS).

However, the technique described in Patent Literature 1 does not take into account harmonics of a power-supply current. Therefore, when a compensation component for the torque pulsation of the motor is generated at a power supply frequency and an asynchronous frequency by using the technique of Patent Literature 1, there is a problem in that the power-supply current is brought into an imbalance state between positive and negative polarities, and a harmonic component of the power-supply current increases.

The present disclosure has been made in view of the above, and an object thereof is to obtain a power conversion apparatus capable of preventing an increase in harmonic component of a power-supply current.

### Means to Solve the Problem

In order to solve the above-described problem and achieve the object, a power conversion apparatus according to the present disclosure is a power conversion apparatus that supplies AC power to a motor that drives a load. The power conversion apparatus includes a converter that rectifies a power-supply voltage applied from an AC power supply, and a capacitor connected to an output end of the converter. Further, the power conversion apparatus includes an inverter connected across the capacitor, and a control device that controls an operation of the inverter. The control device performs a first control of reducing a pulsatile component of a capacitor output current output from the capacitor to the inverter when the load is driven. The first control is control of causing the motor to generate a loss, and the loss that the motor is caused to generate is performed by using an excitation current.

### Effects of the Invention

The power conversion apparatus according to the present disclosure has an effect of being able to prevent an increase in harmonic component of a power-supply current.

### BRIEF DESCRIPTION OF DRAWINGS

FIG. 1 is a diagram illustrating an exemplary configuration of a power conversion apparatus according to a first embodiment.

FIG. 2 is a diagram illustrating an exemplary configuration of an inverter included in the power conversion apparatus according to the first embodiment.

FIG. 3 is a block diagram illustrating an exemplary configuration of a control device included in the power conversion apparatus according to the first embodiment.

FIG. 4 is a first graph for explaining an object of the present application.

FIG. 5 is a second graph for explaining the object of the present application.

FIG. 6 is a block diagram illustrating an exemplary configuration of a voltage command value calculation unit included in the control device according to the first embodiment.

FIG. 7 is a block diagram illustrating an exemplary configuration of a speed control unit included in the voltage command value calculation unit according to the first embodiment.

FIG. 8 is a waveform chart for explaining an operation of a y-axis current compensation unit included in the voltage command value calculation unit according to the first embodiment.

FIG. 9 is a flowchart for explaining an operation of the y-axis current compensation unit included in the voltage command value calculation unit according to the first embodiment.

FIG. 10 is a chart for explaining an effect of the y-axis current compensation control according to the first embodiment.

FIG. 11 is a diagram illustrating an example of a hardware configuration for implementing the control device included in the power conversion apparatus according to the first embodiment.

FIG. 12 is a diagram illustrating an exemplary configuration of a refrigeration cycle application apparatus according to a second embodiment.

### DESCRIPTION OF EMBODIMENTS

Hereinafter, a power conversion apparatus, a motor drive apparatus, and a refrigeration cycle application apparatus according to embodiments of the present disclosure will be described in detail with reference to the accompanying drawings.

### First Embodiment

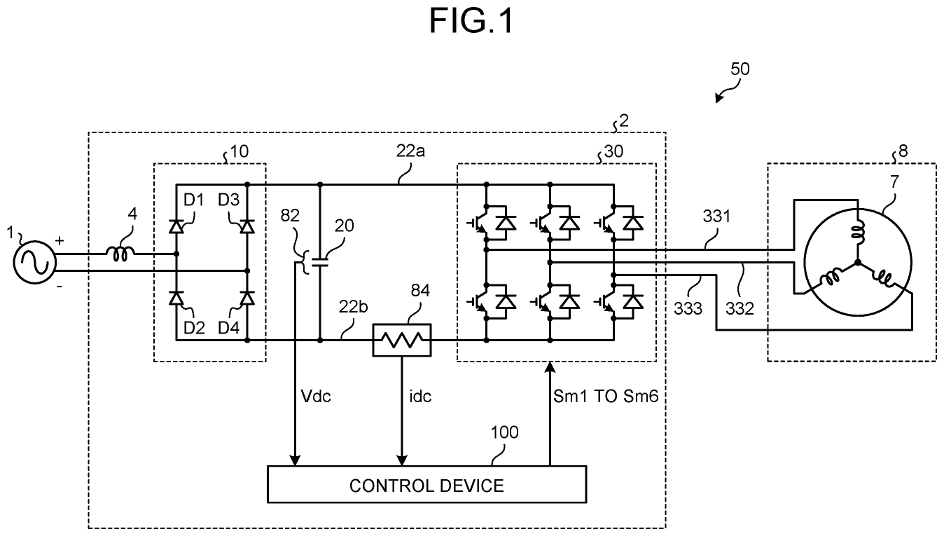

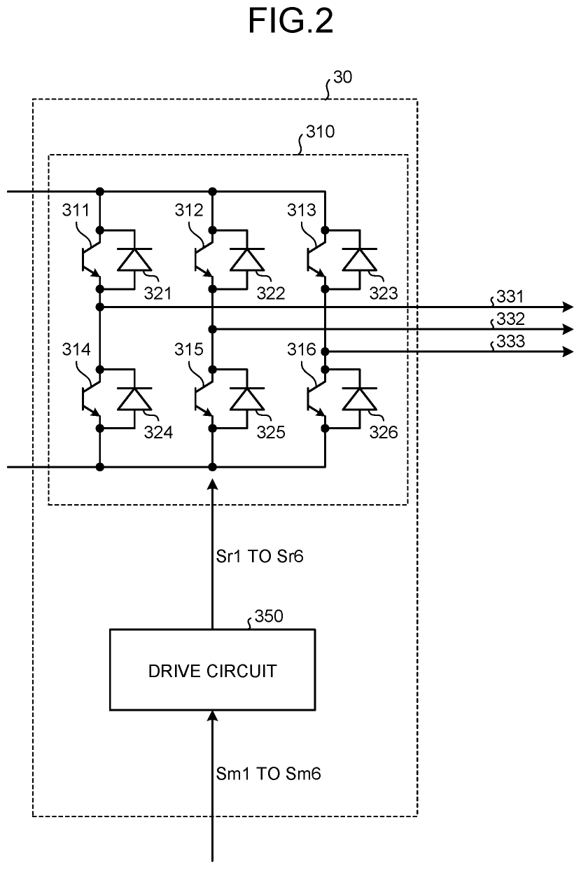

FIG. 1 is a diagram illustrating an exemplary configuration of a power conversion apparatus 2 according to a first embodiment. FIG. 2 is a diagram illustrating an exemplary configuration of an inverter 30 included in the power conversion apparatus 2 according to the first embodiment. The power conversion apparatus 2 is connected to an AC power supply 1 and a compressor 8. The compressor 8 is an example of a load having a characteristic that a load torque periodically fluctuates when driven. The compressor 8 includes a motor 7. An example of the motor 7 is a three-phase permanent magnet synchronous motor. The power conversion apparatus 2 converts a power-supply voltage applied from the AC power supply 1 into an AC voltage having desired amplitude and phase, and applies the AC voltage to the motor 7. The power conversion apparatus 2 includes a reactor 4, a converter 10, a capacitor 20, the inverter 30, a voltage detection unit 82, a current detection unit 84, and a control device 100. The power conversion apparatus 2 and the motor 7 included in the compressor 8 constitute a motor drive apparatus 50.

The converter 10 includes four diodes D1, D2, D3, and D4. The four diodes D1 to D4 are bridge-connected to constitute a rectifier circuit. The converter 10 rectifies a power-supply voltage applied from the AC power supply 1 by the rectifier circuit including the four diodes D1 to D4. In the converter 10, one end on an input side is connected to the AC power supply 1 via the reactor 4, and another end on the input side is connected to the AC power supply 1. Further, in the converter 10, an output side is connected to the capacitor 20.

The converter 10 may have a boosting function of boosting a rectified voltage, together with the rectifying function. The converter having the boosting function may include, in addition to or instead of the diode, one or more transistor elements, or one or more switching elements in each of which a transistor element and a diode are connected in antiparallel. Note that arrangement and connection of the transistor elements or the switching elements in the converter having the boosting function are known, and a description thereof is omitted here.

The capacitor 20 is connected to an output end of the converter 10 via DC buses 22a and 22b. The DC bus 22a is a DC bus on the positive side, and the DC bus 22b is a DC bus on the negative side. The capacitor 20 smooths a rectified voltage applied from the converter 10. Examples of the capacitor 20 include an electrolytic capacitor and a film capacitor.

The inverter 30 is connected across the capacitor 20 via the DC buses 22a and 22b. The inverter 30 converts a DC voltage smoothed by the capacitor 20 into an AC voltage for the compressor 8, and applies the AC voltage to the motor 7 of the compressor 8. The voltage to be applied to the motor 7 is a three-phase AC voltage whose frequency and voltage value are variable.

As illustrated in FIG. 2, the inverter 30 includes an inverter main circuit 310 and a drive circuit 350. The inverter main circuit 310 includes switching elements 311 to 316. To the switching elements 311 to 316, rectifying elements 321 to 326 for reflux are individually connected in antiparallel.

In the inverter main circuit 310, an insulated gate bipolar transistor (IGBT), a metal-oxide-semiconductor field-effect transistor (MOSFET), or the like is assumed as the switching elements 311 to 316, but any element may be used as long as the element can perform switching. Note that, in a case where the switching elements 311 to 316 are MOSFETs, the MOSFET includes a parasitic diode due to its structure. Therefore, a similar effect can be obtained without connecting the rectifying elements 321 to 326 for reflux in antiparallel.

Further, as a material for forming the switching elements 311 to 316, not only silicon (Si) but also silicon carbide (SiC), gallium nitride (GaN), diamond, and the like which are wide bandgap semiconductors may be used. By forming the switching elements 311 to 316 by using the wide bandgap semiconductor, the loss can be further reduced.

The drive circuit 350 generates drive signals Sr1 to Sr6 on the basis of pulse width modulation (PWM) signals Sm1 to Sm6 output from the control device 100. The drive circuit 350 controls on/off of the switching elements 311 to 316 by using the drive signals Sr1 to Sr6. As a result, the inverter 30 can apply a three-phase AC voltage with a variable frequency and a variable voltage to the motor 7 via output lines 331 to 333.

The PWM signals Sm1 to Sm6 are signals having a signal level of a logic circuit, for example, magnitude of 0 V to 5 V. The PWM signals Sm1 to Sm6 are signals whose reference potential is a ground potential of the control device 100. Whereas, the drive signals Sr1 to Sr6 are signals having a voltage level necessary for controlling the switching elements 311 to 316, for example, magnitude of −15 V to +15 V. The drive signals Sr1 to Sr6 are signals whose reference potential is a potential of a negative terminal of each corresponding switching element, that is, an emitter terminal.

The voltage detection unit 82 detects a bus voltage Vdc by detecting a voltage across the capacitor 20. The bus voltage Vdc is a voltage between the DC buses 22a and 22b. The voltage detection unit 82 includes, for example, a voltage dividing circuit that divides a voltage with resistors connected in series. The voltage detection unit 82 converts the detected bus voltage Vdc into a voltage suitable for processing in the control device 100, for example, a voltage of 5 V or less by using the voltage dividing circuit, and outputs the voltage after the conversion to the control device 100 as a voltage detection signal which is an analog signal. The voltage detection signal output from the voltage detection unit 82 to the control device 100 is converted by an analog to digital (AD) converter (not illustrated) in the control device 100 from an analog signal into a digital signal, and is used for internal processing in the control device 100.

The current detection unit 84 includes a shunt resistor inserted into the DC bus 22b. The current detection unit 84 detects a capacitor output current iδc by using the shunt resistor. The capacitor output current iδc is an input current to the inverter 30, that is, a current output from the capacitor 20 to the inverter 30. The current detection unit 84 outputs the detected capacitor output current iδc to the control device 100 as a current detection signal which is an analog signal. The current detection signal output from the current detection unit 84 to the control device 100 is converted by an AD converter (not illustrated) in the control device 100 from an analog signal into a digital signal, and is used for internal processing in the control device 100.

The control device 100 generates the PWM signals Sm1 to Sm6 described above, and controls an operation of the inverter 30. Specifically, the control device 100 changes an angular frequency we and a voltage value of an output voltage of the inverter 30 on the basis of the PWM signals Sm1 to Sm6.

The angular frequency we of the output voltage of the inverter 30 determines a rotational angular speed at an electrical angle of the motor 7. In this description, this rotational angular speed is also represented by the identical sign we. A rotational angular speed om at a mechanical angle of the motor 7 is equal to a value obtained by dividing the rotational angular speed we at the electrical angle of the motor 7 by the number of pole pairs P. Therefore, there is a relationship expressed by the following Equation (1) between the rotational angular speed om at the mechanical angle of the motor 7 and the angular frequency we of the output voltage of the inverter 30. Note that, in this description, the rotational angular speed may be simply referred to as a “rotation speed”, and the angular frequency may be simply referred to as a “frequency”.

$$Formula 1$$

$$ω m = ω e / P \qquad ( 1 )$$

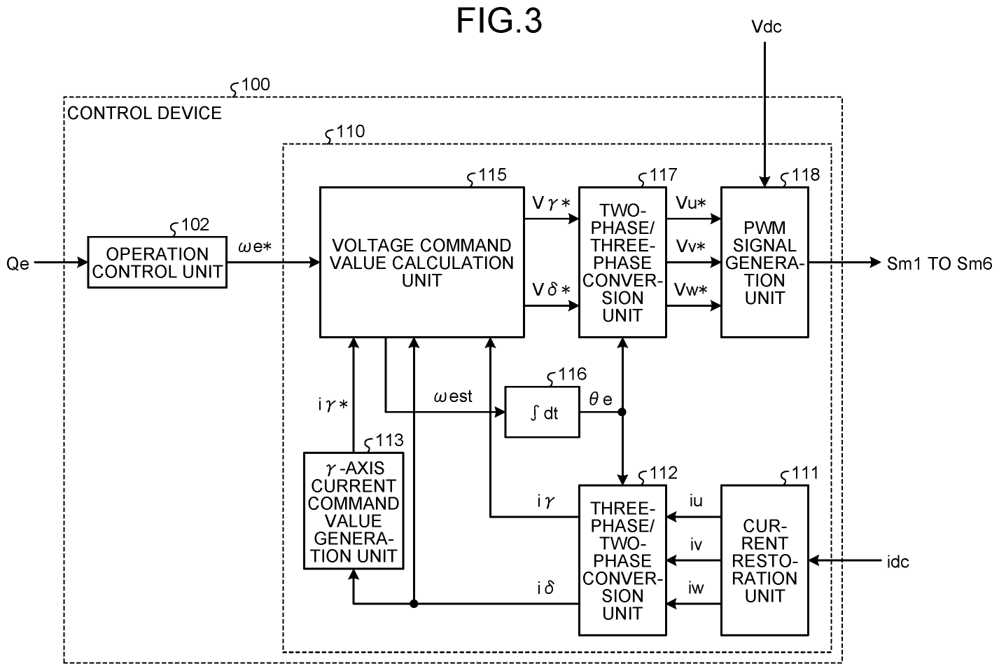

Next, the configuration of the control device 100 will be described with reference to FIG. 3. Note that, in this description, a yδ-axis coordinate system generally used in position sensorless control will be described as a coordinate system of the control unit constructed in the control device 100, but the present disclosure is not limited thereto. For example, when the motor 7 is a permanent magnet motor, a dq-axis coordinate system may be used in which an N-pole of a magnetic pole is a d-axis and an axis orthogonal to the d-axis is a q-axis. In this case, in the processing of the control device 100, as long as the y-axis is set such that there is no axial error between the y-axis and the d-axis, the y-axis and the δ-axis can be handled as the d-axis and the q-axis, respectively. In addition, even when there is an axial error between the y-axis and the d-axis, the y-axis and the δ-axis can be regarded as the d-axis and the q-axis, respectively, as long as a control amount is handled in consideration of a difference corresponding to the axial error.

FIG. 3 is a block diagram illustrating an exemplary configuration of the control device 100 included in the power conversion apparatus 2 according to the first embodiment. The control device 100 includes an operation control unit 102 and an inverter control unit 110.

The operation control unit 102 receives command information Qe from the outside, and generates a frequency command value ωe* on the basis of the command information Qe. The frequency command value ωe* can be obtained by multiplying a rotational speed command value om*, which is a command value of the rotational speed of the motor 7, by the number of pole pairs P as expressed in the following Equation (2).

$$Formula 2$$

$$ω e *= ω m * \cdot P \qquad ( 2 )$$

When controlling an air conditioner as the refrigeration cycle application apparatus, the control device 100 controls an operation of each unit of the air conditioner on the basis of the command information Qe. The command information Qe is, for example, a temperature detected by a temperature sensor (not illustrated), information indicating a set temperature provided by a remote controller which is an operation unit (not illustrated), operation mode selection information, instruction information for operation start and operation end, and the like. The operation mode is, for example, heating, cooling, dehumidification, and the like. Note that, the operation control unit 102 may be external to the control device 100. That is, the control device 100 may be configured to acquire the frequency command value ωe* from the outside.

The inverter control unit 110 includes a current restoration unit 111, a three-phase/two-phase conversion unit 112, a y-axis current command value generation unit 113, a voltage command value calculation unit 115, an electrical phase calculation unit 116, a two-phase/three-phase conversion unit 117, and a PWM signal generation unit 118.

The current restoration unit 111 restores phase currents iu, iv, and iw flowing through the motor 7, on the basis of the capacitor output current iδc detected by the current detection unit 84. The current restoration unit 111 can restore the phase currents iu, iv, and iw by sampling a detected value of the capacitor output current idc detected by the current detection unit 84 at a timing determined on the basis of the PWM signals Sm1 to Sm6 generated by the PWM signal generation unit 118. Note that a current detector may be provided in the output lines 331 to 333 to directly detect the phase currents iu, iv, and iw, and input the phase currents iu, iv, and iw to the three-phase/two-phase conversion unit 112. In a case of this configuration, the current restoration unit 111 is unnecessary.

The three-phase/two-phase conversion unit 112 converts the phase currents iu, iv, and iw restored by the current restoration unit 111 into a y-axis current iy which is an excitation current and a δ-axis current iδ which is a torque current, that is, current values of Y-δ axes, by using an electrical phase de generated by the electrical phase calculation unit 116 described later.

The y-axis current command value generation unit 113 generates a y-axis current command value iy* which is an excitation current command value, on the basis of the δ-axis current iδ. More specifically, the y-axis current command value generation unit 113 obtains a current phase angle at which the output torque of the motor 7 is equal to or larger than the set value or becomes the maximum value on the basis of the δ-axis current iδ, and calculates the Y-axis current command value iy* on the basis of the obtained current phase angle. Note that, instead of the output torque of the motor 7, a motor current flowing through the motor 7 may be used. In this case, the y-axis current command value iy* is calculated on the basis of the current phase angle at which the motor current flowing through the motor 7 is equal to or less than the set value or becomes the minimum value. Further, in this description, the y-axis current command value generation unit may be simply referred to as a “command value generation unit”.

Further, FIG. 3 illustrates a configuration for obtaining the y-axis current command value iy* on the basis of the δ-axis current iδ, but the present disclosure is not limited to this configuration. Instead of the δ-axis current iδ, the y-axis current command value iy* may be obtained on the basis of the y-axis current iy. Further, the y-axis current command value generation unit 113 may determine the y-axis current command value iy* by flux weakening control.

The voltage command value calculation unit 115 generates a y-axis voltage command value Vy* and a δ-axis voltage command value Vδ*, on the basis of the frequency command value ωe* acquired from the operation control unit 102, the y-axis current iy and the δ-axis current iδ acquired from the three-phase/two-phase conversion unit 112, and the y-axis current command value iy* acquired from the y-axis current command value generation unit 113. Further, the voltage command value calculation unit 115 estimates a frequency estimation value west on the basis of the y-axis voltage command value Vy*, the δ-axis voltage command value Vδ*, the y-axis current iy, and the δ-axis current iδ.

The electrical phase calculation unit 116 calculates the electrical phase de by integrating the frequency estimation value west acquired from the voltage command value calculation unit 115.

The two-phase/three-phase conversion unit 117 converts the y-axis voltage command value Vy* and the δ-axis voltage command value Vδ* acquired from the voltage command value calculation unit 115, that is, voltage command values of a two-phase coordinate system into three-phase voltage command values Vu*, Vv*, and Vw* which are output voltage command values of a three-phase coordinate system, by using the electrical phase de acquired from the electrical phase calculation unit 116.

The PWM signal generation unit 118 compares the three-phase voltage command values Vu*, Vv*, and Vw* acquired from the two-phase/three-phase conversion unit 117 with the bus voltage Vdc detected by the voltage detection unit 82, to generate the PWM signals Sm1 to Sm6. Note that, the PWM signal generation unit 118 can stop the motor 7 by not outputting the PWM signals Sm1 to Sm6.

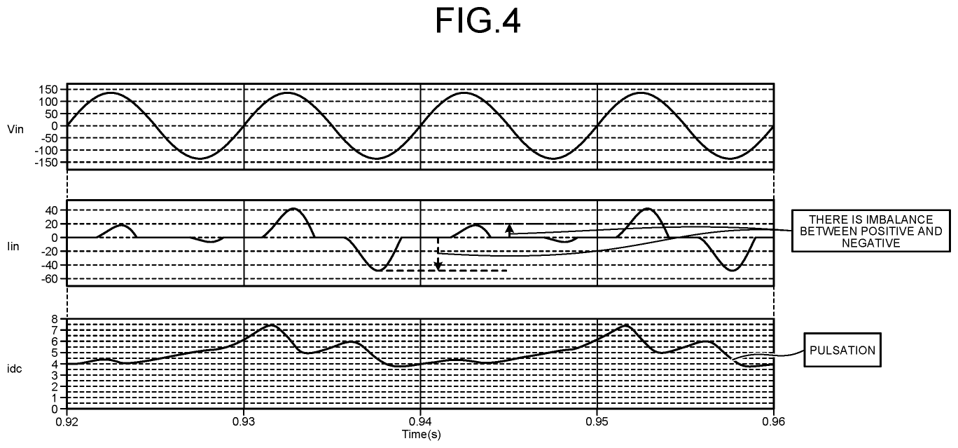

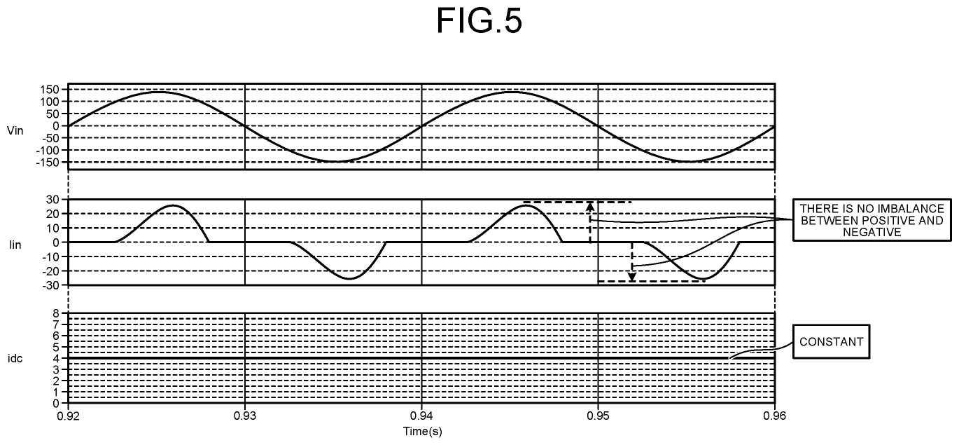

Next, the reason why the problem of the present application occurs will be described. FIGS. 4 and 5 are first and second graphs, respectively, for explaining the problem of the present application. The problem of the present application has been briefly described in the section of [Problem to be solved by the Invention], but a more detailed description will be added here.

First, when the load is a load having torque pulsation, such as a single rotary compressor, a scroll compressor, or a twin rotary compressor, control of compensating for the torque pulsation is performed as described in the section of [Background]. This control is also called “vibration prevention control”. In the general vibration prevention control, the inverter 30 is controlled by generating a torque current compensation value so that the output torque of the motor 7 follows the torque pulsation. However, when this control is simply performed, as described in the section of [Problem to be solved by the Invention], the problem occurs in which a power-supply current Iin is brought into an imbalance state between positive and negative polarities, and a harmonic component of the power-supply current increases.

FIGS. 4 and 5 illustrate waveforms of a power-supply voltage Vin, the power-supply current Iin, and the capacitor output current iδc in order from the upper stage. The horizontal axis in FIGS. 4 and 5 represents time.

The middle stage of FIG. 4 illustrates a state in which a peak value of a waveform on the positive side and a peak value of a waveform on the negative side in the power-supply current Iin are different, that is, a state in which there is an imbalance of the peak value between the positive and negative polarities of the power-supply current Iin. When such an imbalance occurs, as illustrated in the lower stage, pulsation occurs in the capacitor output current iδc. As a result, the power-supply current Iin includes a lot of harmonic components.

Note that, it has been found by the inventors of the present application that the pulsation of the capacitor output current iδc increases as the load torque increases and inertia of the load decreases, and remarkably appears when the load torque is large during the vibration prevention control. In addition, it has been found by the inventors of the present application that the pulsation of the capacitor output current iδc is larger in a single rotary compressor than in a twin rotary compressor and a scroll compressor.

Further, the lower stage of FIG. 5 illustrates an ideal state in which the capacitor output current iδc is constant. In such an ideal state, as illustrated in the middle stage of FIG. 5, a peak value of a waveform on the positive side and a peak value of a waveform on the negative side in the power-supply current Iin are equal, and the imbalance between positive and negative in the power-supply current Iin does not occur. Therefore, the harmonic component that can be included in the power-supply current Iin is much less than that in the case of FIG. 4.

As described above, the harmonic component that can be included in the power-supply current Iin is related to the pulsation of the capacitor output current iδc. Therefore, the voltage command value calculation unit 115 included in the control device 100 according to the first embodiment performs control to reduce a pulsatile component of the capacitor output current iδc when the load is driven. Note that, in this description, this control may be referred to as “first control”.

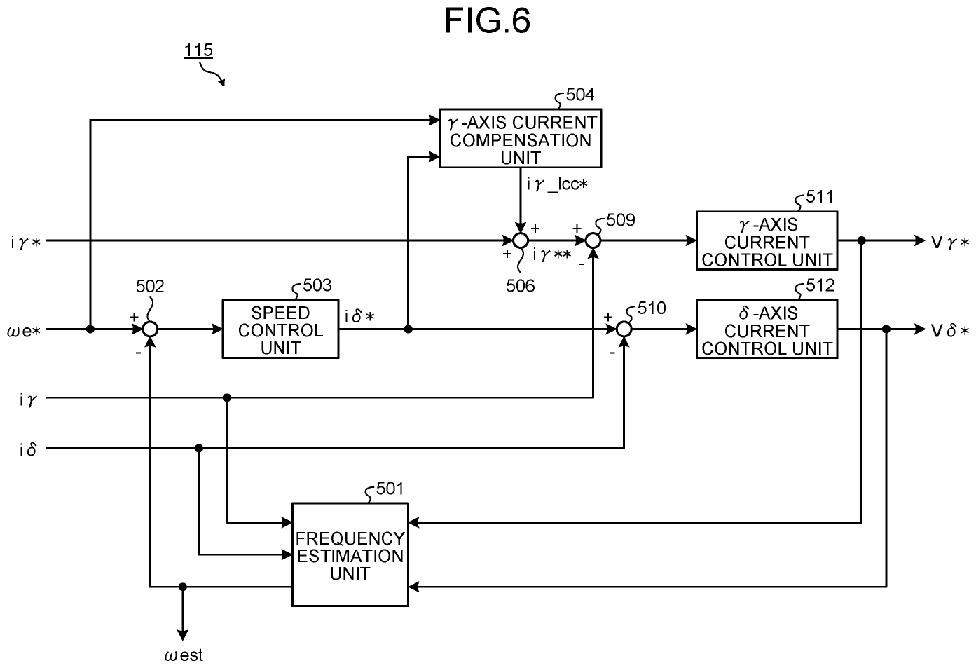

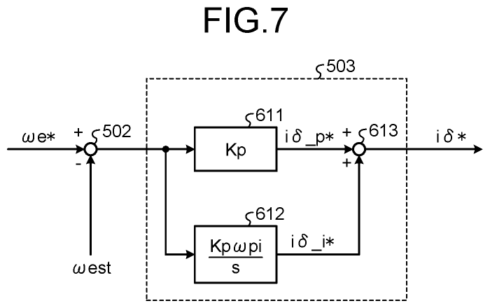

FIG. 6 is a block diagram illustrating an exemplary configuration of the voltage command value calculation unit 115 included in the control device 100 according to the first embodiment. As illustrated in FIG. 6, the voltage command value calculation unit 115 includes a frequency estimation unit 501, subtraction units 502, 509, and 510, a speed control unit 503, a y-axis current compensation unit 504, an addition unit 506, a y-axis current control unit 511, and a δ-axis current control unit 512. Further, FIG. 7 is a block diagram illustrating an exemplary configuration of the speed control unit 503 included in the voltage command value calculation unit 115 according to the first embodiment. Note that, FIG. 7 also illustrates the subtraction unit 502 positioned at a preceding stage of the speed control unit 503.

The frequency estimation unit 501 estimates a frequency of a voltage to be applied to the motor 7 on the basis of the y-axis current iy, the δ-axis current iδ, the Y-axis voltage command value Vy*, and the δ-axis voltage command value Vδ*, and outputs the estimated frequency as the frequency estimation value west.

The subtraction unit 502 calculates a difference (ωe*-west) between the frequency command value ωe* and the frequency estimation value west estimated by the frequency estimation unit 501.

The speed control unit 503 generates a δ-axis current command value iδ* which is a torque current command value in a rotating coordinate system. More specifically, the speed control unit 503 performs proportional integral calculation, that is, proportional integral (PI) control on the difference (ωe*-west) calculated by the subtraction unit 502, to calculate the δ-axis current command value iδ* that brings the difference (ωe*-west) close to 0.

FIG. 7 illustrates an exemplary configuration of the speed control unit 503. As illustrated in FIG. 7, the speed control unit 503 is a control unit that generates a current command value on the basis of a frequency deviation. The speed control unit 503 includes a proportional control unit 611, an integral control unit 612, and an addition unit 613.

In the speed control unit 503, the proportional control unit 611 performs proportional control on the difference (ωe*-west) between the frequency command value ωe* and the frequency estimation value west acquired from the subtraction unit 502, and outputs a proportional term iδ_p*. The integral control unit 612 performs integral control on the difference (ωe*-west) between the frequency command value ωe* and the frequency estimation value west acquired from the subtraction unit 502, and outputs an integral term iδ_i*. The addition unit 613 adds the proportional term iδ_p* acquired from the proportional control unit 611 and the integral term id i* acquired from the integral control unit 612 together, to generate the δ-axis current command value iδ*.

As described above, the speed control unit 503 generates and outputs the δ-axis current command value iδ* that causes the frequency estimation value west to coincide with the frequency command value ωe*.

Returning to FIG. 6, the y-axis current compensation unit 504 generates a y-axis current compensation value iy_lcc* on the basis of the frequency command value ωe* and the δ-axis current command value iδ* output from the speed control unit 503. The y-axis current compensation value iy_lcc* is a component of a control amount for reducing a pulsatile component of the capacitor output current iδc. Details of the y-axis current compensation value iy_lcc* will be described later. Note that, in this description, the y-axis current compensation unit may be simply referred to as a “current compensation unit”, and the y-axis current compensation value may be simply referred to as a “current compensation value”. In addition, in this description, the control by the y-axis current compensation unit 504 may be referred to as “y-axis current compensation control”.

The addition unit 506 adds together the y-axis current command value iy* and the y-axis current compensation value iy_lcc* acquired from the y-axis current compensation unit 504, that is, superimposes the y-axis current compensation value iy_lcc* on the y-axis current command value iy*, to generate a y-axis current command value iy**. The generated Y-axis current command value iv** is input to the subtraction unit 509.

The subtraction unit 509 calculates a difference (iv**-iv) of the y-axis current iy with respect to the y-axis current command value iy**. The subtraction unit 510 calculates a difference (iδ*-iδ) of the δ-axis current iδ with respect to the δ-axis current command value iδ*.

The y-axis current control unit 511 performs proportional integral calculation on the difference (iv**-iy) calculated by the subtraction unit 509, to generate the Y-axis voltage command value Vy* that brings the difference (iv**-iv) close to 0. The y-axis current control unit 511 performs control to cause the y-axis current iy to coincide with the y-axis current command value iy**, by generating such a y-axis voltage command value VY*.

The δ-axis current control unit 512 performs proportional integral calculation on the difference (iδ*-iδ) calculated by the subtraction unit 510, to generate the δ-axis voltage command value Vδ* that brings the difference (iδ*-iδ) close to 0. The δ-axis current control unit 512 performs control to cause the δ-axis current iδ to coincide with the δ-axis current command value iδ*, by generating such a δ-axis voltage command value Vδ*.

In the control described above, the y-axis current command value iy** output from the subtraction unit 509 and input to the y-axis current control unit 511 includes the y-axis current compensation value iy_lcc* acquired from the y-axis current compensation unit 504. Therefore, when the y-axis current control unit 511 controls the inverter 30 on the basis of the y-axis voltage command value Vy* generated on the basis of the y-axis current compensation value iy_lcc*, the pulsation of the capacitor output current iδc can be reduced.

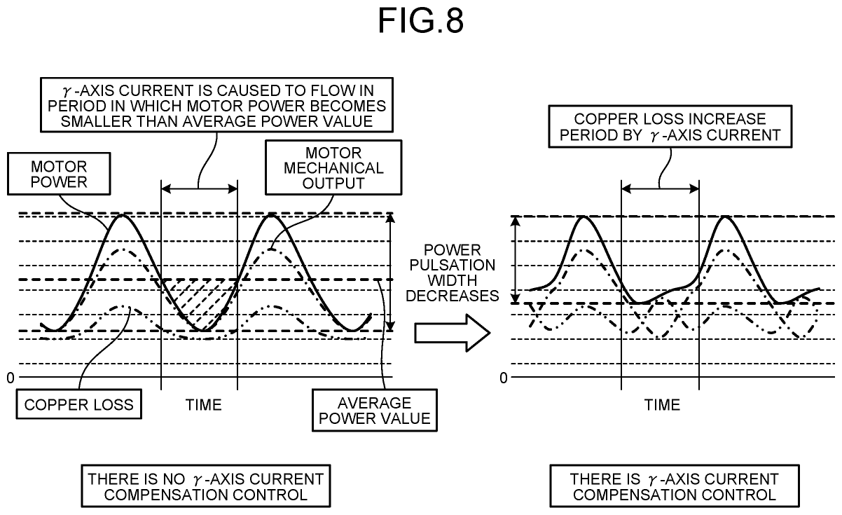

Next, main points of an operation of the y-axis current compensation unit 504 included in the voltage command value calculation unit 115 according to the first embodiment will be described with reference to some mathematical formulas and FIG. 8. FIG. 8 is a waveform chart for explaining an operation of the y-axis current compensation unit 504 included in the voltage command value calculation unit 115 according to the first embodiment.

First, motor power which is active power supplied from the inverter 30 to the motor 7 is represented by Pm. The motor power Pm can be expressed by the following Equation (3).

$$Formula 3$$

$$\begin{matrix}Pm = V γ \cdot i γ + V δ \cdot i δ \\ = ( Ra \cdot i γ - ω e \cdot L δ \cdot i δ ) i γ + ( Ra \cdot i δ + ω e ( L γ \cdot i γ + φ a ) i δ \\ = Ra \cdot i {γ}^{2} - ω e \cdot L δ \cdot i δ \cdot i γ + Ra \cdot i {δ}^{2} + ω e ( L γ \cdot i γ + φ a ) i δ \\ = Ra ( i {γ}^{2} + i {δ}^{2} ) + ω e \cdot i δ ( φ a + ( L γ - L δ ) i γ )\end{matrix} \qquad ( 3 )$$

Meanings of symbols shown in the above Equation (3) are as follows.
VY: a y-axis voltage in the motor 7
Vδ: a δ-axis voltage in the motor 7
iv: a y-axis current flowing through the motor 7
iδ: a δ-axis current flowing through the motor 7
Ra: a phase resistance in the motor 7
ωe: a frequency (electrical angle) of an output voltage of the inverter 30
LY: a y-axis inductance in the motor 7
Lδ: a δ-axis inductance in the motor 7
φa: an induced voltage constant in the motor 7

Furthermore, when the power supplied from the capacitor 20 to the inverter 30 is represented by Pdc, Pm≈Pdc can be considered. Therefore, from the above Equation (3), the capacitor output current iδc can be expressed by the following Equation (4).

$$Formula 4$$

$$\begin{matrix}idc = Pdc / Vdc \\ \approx Pm / Vdc \\ = Ra ( i {γ}^{2} + i {δ}^{2} ) / Vdc + ω e \cdot i δ ( φ a + ( L γ - L δ ) i γ ) / {Vdc}^{}\end{matrix} \qquad {( 4 )}^{}$$

The first term on the right side of the above Equation (4) is a term representing a copper loss of the motor 7, and the second term on the right side of the above Equation (4) is a term representing a mechanical output of the motor 7 (hereinafter referred to as a “motor mechanical output”). That is, it can be seen that the capacitor output current iδc is affected by the copper loss of the motor 7 and the motor mechanical output.

The left graph of FIG. 8 illustrates waveforms related to the motor power Pm, the motor mechanical output, and the copper loss of the motor 7 of a case where the y-axis current compensation control is not performed. The case where the y-axis current compensation control is not performed means that the y-axis current compensation control function is not activated. In addition, the right graph of FIG. 8 illustrates waveforms related to the motor power Pm, the motor mechanical output, and the copper loss of the motor 7 of a case where the y-axis current compensation control is performed. The case where the y-axis current compensation control is performed means that the y-axis current compensation control function is activated. In both graphs, a solid line represents the motor power Pm, a one dotted chain line represents motor mechanical output, and a two-dot chain line represents a copper loss of the motor 7. Further, the horizontal axis represents time. Note that, in order to prevent activation of the y-axis current compensation control function, the operation of the y-axis current compensation unit 504 in FIG. 6 may simply be stopped, or the output of the y-axis current compensation unit 504 may simply be prevented from being input to the addition unit 506.

As described above, the compressor 8 is a load having torque pulsation. Therefore, speed pulsation and pulsation of the δ-axis current inevitably occur, and as a result, the motor power Pm and the motor mechanical output also pulsate as illustrated in the left graph of FIG. 8. Further, in the above Equation (4), power of the second term on the right side representing the motor mechanical output is dominant as compared with power of the first term on the right side representing the copper loss of the motor 7. Therefore, when the power of the second term on the right side pulsates, the pulsation of the capacitor output current iδc also increases, and the harmonic component included in the power-supply current Iin increases.

Therefore, in the first embodiment, in order to reduce the pulsation of the capacitor output current iδc, control is performed to increase the copper loss of the motor 7 in a period in which the motor power Pm becomes smaller than a set power value. Note that, in this description, the period in which the motor power Pm becomes smaller than the set power value is appropriately referred to as a “first period”.

Here, as can be understood from the first term and the second term on the right side of the above Equation (4), the copper loss of the motor 7 increases by increasing the δ-axis current, but the mechanical output of the motor 7 also increases. Therefore, in the first embodiment, a method of increasing the y-axis current iy to increase the copper loss of the motor 7 is adopted.

The left graph of FIG. 8 illustrates an example in which the set power value is an average power value Pavg which is an average value of the motor power Pm. Note that the average power value Pavg mentioned here is an average value of the motor power Pm obtained when the y-axis current compensation control according to the first embodiment is not performed. Further, in the left graph of FIG. 8, a portion surrounded by the motor power Pm and the average power value Pavg is indicated by hatching. The width in the time axis direction of the portion indicated by the hatching corresponds to the above-described first period. In addition, the right graph of FIG. 8 illustrates that, by the control of increasing the y-axis current iy, the copper loss of the motor 7 increases, a waveform of a downwardly convex portion of the motor power Pm is raised, and the pulsation width of the motor power Pm decreases, in the first period.

Note that the direction in which the y-axis current iy flows may be either positive or negative direction. Since the copper loss of the motor 7 is directly proportional to the square of the current, the copper loss can be generated in the motor 7 in either positive or negative direction. Therefore, in order to increase the copper loss of the motor 7, the absolute value of the y-axis current iy may simply be increased.

Further, when the motor 7 is, for example, an embedded permanent magnet motor, the direction in which the Y-axis current iy flows is preferably negative. This point will be described below.

In the second term on the right side of the above Equation (4), “(Ly-Lδ) iy” is a term representing power related to reluctance torque. When the motor 7 is an embedded permanent magnet motor, the relationship between the y-axis inductance Ly and the δ-axis inductance Lδ is generally Ly<Lδ. This relationship is called “reverse salient pole”. When the motor 7 has the reverse salient pole and the y-axis current iy flows in the negative direction, the value of “(Ly-Lδ) iy” becomes positive. Therefore, when the y-axis current iy flows in the negative direction, the value of the reluctance torque becomes positive, so that control is performed in a direction in which driving of the motor 7 is stabilized. As a result, it is possible to reduce a possibility that the motor 7 is brought into a step-out state while preventing an increase in harmonic component of the power-supply current.

In addition, in a case where the power conversion apparatus 2 has a function of the flux weakening control and the motor 7 has the reverse salient pole, the y-axis current iy flows in the negative direction when the flux weakening control is performed in an overmodulation region. Therefore, the control of causing the y-axis current iy to flow in the negative direction is advantageous for the flux weakening control in the motor 7 having the reverse salient pole.

Note that, although the method of increasing the copper loss of the motor 7 has been described above, the present disclosure is not limited to this method. Any method may be used as long as a loss of the motor 7 can be increased in a period in which active power of the motor 7 decreases. For example, in the period in which the active power of the motor 7 decreases, a method of increasing an iron loss of the motor 7 or a method of increasing a switching loss in the inverter main circuit 310 may be used.

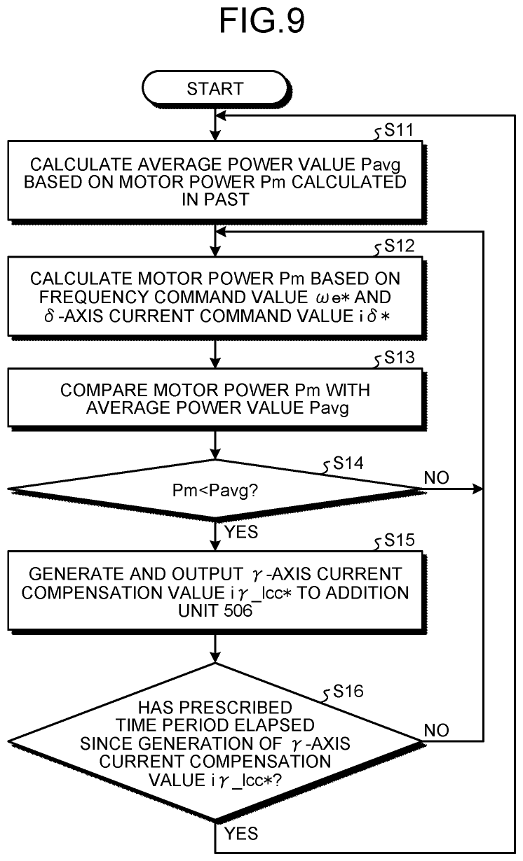

FIG. 9 is a flowchart for explaining an operation of the y-axis current compensation unit 504 included in the voltage command value calculation unit 115 according to the first embodiment.

In the control device 100, the y-axis current compensation unit 504 calculates the average power value Pavg on the basis of the motor power Pm calculated in the past (step S11). Further, the y-axis current compensation unit 504 calculates the current motor power Pm on the basis of the frequency command value ωe* and the δ-axis current command value is* (step S12). Further, the y-axis current compensation unit 504 compares the motor power Pm with the average power value Pavg (step S13).

When the motor power Pm is not lower than the average power value Pavg (step S14, No), the process returns to step S12, and the process of steps S12 and S13 is repeated. Whereas, when the motor power Pm is lower than the average power value Pavg (step S14, Yes), the y-axis current compensation unit 504 generates the y-axis current compensation value iy_lcc* and outputs the y-axis current compensation value iy_lcc* to the addition unit 506 (step S15). The y-axis current compensation unit 504 determines whether or not a prescribed time period has elapsed since the generation of the y-axis current compensation value iy_lcc* (step S16). When the prescribed time period has not elapsed (step S16, No), the process returns to step S12, and the process from step S12 is repeated. Whereas, when the prescribed time period has elapsed (step S16, Yes), the process returns to step S11, and the process from step S11 is repeated.

The above process will be partially supplemented. In step S15, the absolute value of the y-axis current compensation value iy_lcc* output to the addition unit 506 may simply be determined in accordance with magnitude of the motor power Pm. The waveform of the motor power Pm of a case where the y-axis current compensation control is not performed has a substantially sinusoidal shape as illustrated in the left graph of FIG. 8. Therefore, the shape of the y-axis current compensation value iy_lcc* may simply be controlled such that the absolute value of the y-axis current compensation value iy_lcc* increases when a drop of the motor power Pm is large, and a change in amplitude of the y-axis current compensation value iy_lcc* becomes a sine wave. Note that the shape of the y-axis current compensation value iy_lcc* is not necessarily a sine wave, and may be a triangular wave, a trapezoidal wave, or a rectangular wave.

Further, the prescribed time period in step S16 can be determined on the basis of the cycle of the motor power Pm and the average power value Pavg. Further, the average power value Pavg in step S11 may be calculated on the basis of the motor power Pm one cycle before, or may be calculated on the basis of the motor power Pm of a plurality of cycles including one cycle before. Further, in step S12, the motor power Pm is calculated on the basis of not a measurement value but the frequency command value ωe* and the δ-axis current command value iδ* which are command values, so that it is possible to grasp the motor power Pm of a case where the y-axis current compensation control is not performed.

Further, in the flowchart of FIG. 9, the y-axis current compensation value iy_lcc* is calculated on the basis of the motor power Pm and the average power value Pavg which is an average value of the motor power Pm, but the present disclosure is not limited to this. The rotational speed of the motor 7 may be regarded as being constant, and the y-axis current compensation value iy_lcc* may be calculated on the basis of the δ-axis current command value iδ* and an average value thereof. Alternatively, the d-axis current iδ of the motor 7 may be regarded as being constant, and the y-axis current compensation value iy_lcc* may be calculated on the basis of the frequency estimation value west and an average value thereof.

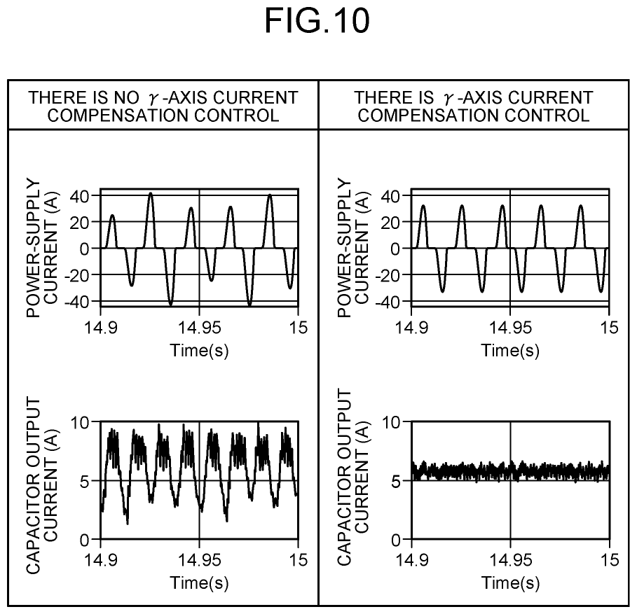

FIG. 10 is a chart for explaining an effect of the y-axis current compensation control according to the first embodiment. The left part of FIG. 10 illustrates waveforms of a power-supply current and a capacitor output current of a case where the y-axis current compensation control is not performed. Further, the right part of FIG. 10 illustrates waveforms of a power-supply current and a capacitor output current of a case where the y-axis current compensation control is performed.

When the y-axis current compensation control is not performed, pulsation of the capacitor output current is large as illustrated in the left part of FIG. 10. This shows that a peak value of the power-supply current fluctuates and a harmonic component included in the power-supply current increases. On the other hand, when the y-axis current compensation control is performed, pulsation of the capacitor output current is small as illustrated in the right part of FIG. 10. This shows that a peak value of the power-supply current becomes substantially constant, and a harmonic component included in the power-supply current is reduced.

As described above, the power conversion apparatus according to the first embodiment performs the first control of reducing pulsation of a capacitor output current output from the capacitor to the inverter when the load is driven. The first control is control of causing the motor to generate a loss, and the loss that the motor is caused to generate is performed by using an excitation current. By this control, the pulsation width of the motor power can be reduced. As a result, it is possible to prevent the power-supply current from being in an imbalance state between positive and negative polarities, and it is possible to prevent an increase in harmonic component that can be included in the power-supply current. In addition, since the imbalance state between positive and negative of the power-supply current is prevented, it is easy to conform to a power supply harmonic standard. This eliminates the need to change or modify a circuit constant of the converter and a switching method of the converter, so that an inexpensive and highly reliable motor drive apparatus can be obtained. In addition, since a power supply power factor also increases due to the reduction of the power supply harmonics, a useless current no longer needs to flow. As a result, efficiency on the converter side can be increased.

Note that the first control described above can be realized by causing the motor to generate a loss in the first period in which motor power, which is power supplied from the inverter to the motor, becomes smaller than a set power value. The set power value may be an average value of the motor power obtained when the first control is not performed. Further, in order to cause the motor to generate a loss, the absolute value of an excitation current may simply be increased.

In addition, the value of the excitation current when the motor is caused to generate the loss is preferably negative. When the value of the excitation current is negative, it is possible to reduce a possibility that the motor is brought into a step-out state while preventing an increase in harmonic component of the power-supply current. Further, when the motor 7 has the reverse salient pole, control of causing the negative excitation current to flow in the negative direction coincides with a direction in which the flux weakening control is strengthened. Therefore, it is possible to achieve both the first control of reducing pulsation of the capacitor output current and the flux weakening control, without forming a complicated control system.

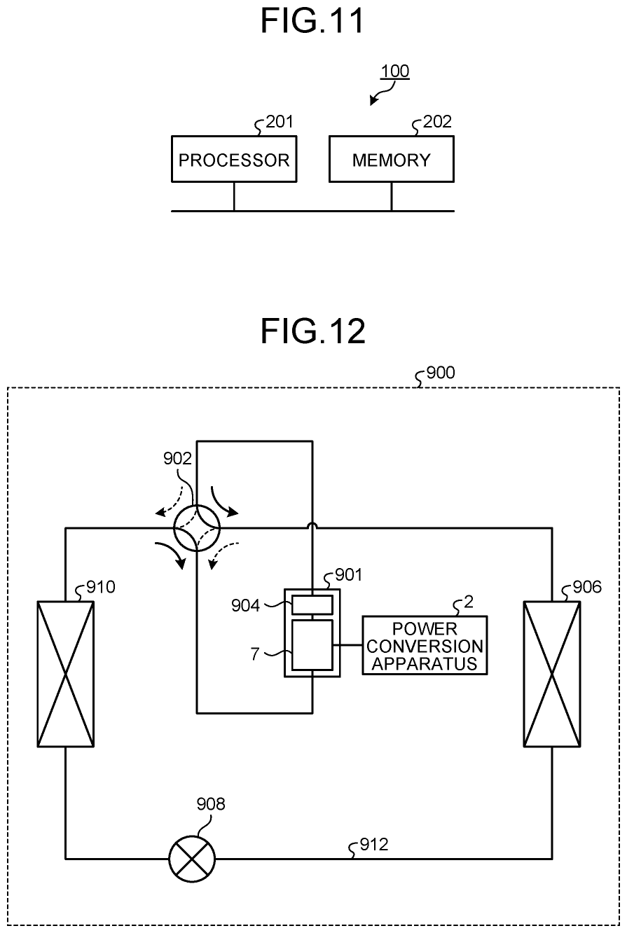

Next, a hardware configuration of the control device 100 included in the power conversion apparatus 2 will be described. FIG. 11 is a diagram illustrating an example of a hardware configuration for implementing the control device 100 included in the power conversion apparatus 2 according to the first embodiment. The control device 100 is implemented by a processor 201 and a memory 202.

The processor 201 is a central processing unit (CPU) (also referred to as a central processing device, a processing unit, an arithmetic unit, a microprocessor, a microcomputer, a processor, or a digital signal processor (DSP)) or a system large scale integration (LSI). The memory 202 can be exemplified by a nonvolatile or volatile semiconductor memory such as a random access memory (RAM), a read only memory (ROM), a flash memory, an erasable programmable read only memory (EPROM), or an electrically erasable programmable read-only memory (EEPROM) (registered trademark). In addition, the memory 202 is not limited thereto, and may be a magnetic disk, an optical disk, a compact disk, a mini disk, or a digital versatile disc (DVD).

### Second Embodiment

FIG. 12 is a diagram illustrating an exemplary configuration of a refrigeration cycle application apparatus 900 according to a second embodiment. The refrigeration cycle application apparatus 900 according to the second embodiment includes the power conversion apparatus 2 described in the first embodiment. The refrigeration cycle application apparatus 900 according to the second embodiment can be applied to a product including a refrigeration cycle, such as an air conditioner, a refrigerator, a freezer, or a heat pump water heater. Note that, in FIG. 12, components having functions similar to those of the first embodiment are denoted by reference numerals identical to those of the first embodiment.

The refrigeration cycle application apparatus 900 includes a compressor 901 incorporating the motor 7 according to the first embodiment, a four-way valve 902, an indoor heat exchanger 906, an expansion valve 908, and an outdoor heat exchanger 910, which are connected via a refrigerant pipe 912.

Inside the compressor 901, a compression mechanism 904 that compresses a refrigerant, and the motor 7 that operates the compression mechanism 904 are provided.

The refrigeration cycle application apparatus 900 can perform heating operation or cooling operation by a switching operation of the four-way valve 902. The compression mechanism 904 is driven by the motor 7 subjected to variable-speed control.

During the heating operation, as indicated by solid arrows, the refrigerant is pressurized and fed by the compression mechanism 904, and returns to the compression mechanism 904 through the four-way valve 902, the indoor heat exchanger 906, the expansion valve 908, the outdoor heat exchanger 910, and the four-way valve 902.

During the cooling operation, as indicated by broken arrows, the refrigerant is pressurized and fed by the compression mechanism 904, and returns to the compression mechanism 904 through the four-way valve 902, the outdoor heat exchanger 910, the expansion valve 908, the indoor heat exchanger 906, and the four-way valve 902.

During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 decompresses and expands the refrigerant.

The configurations illustrated in the above embodiments illustrate one example and can be combined with another known technique, and it is also possible to omit and change a part of the configuration without departing from the subject matter.

### REFERENCE SIGNS LIST

1 AC power supply; 2 power conversion apparatus; 4 reactor; 7 motor; 8 compressor; 10 converter; 20 capacitor; 22a, 22b DC bus; 30 inverter; 50 motor drive apparatus; 82 voltage detection unit; 84 current detection unit; 100 control device; 102 operation control unit; 110 inverter control unit; 111 current restoration unit; 112 three-phase/two-phase conversion unit; 113 y-axis current command value generation unit; 115 voltage command value calculation unit; 116 electrical phase calculation unit; 117 two-phase/three-phase conversion unit; 118 PWM signal generation unit; 201 processor; 202 memory; 310 inverter main circuit; 311 to 316 switching element; 321 to 326 rectifying element; 331 to 333 output line; 350 drive circuit; 501 frequency estimation unit; 502, 509, 510 subtraction unit; 503 speed control unit; 504 y-axis current compensation unit; 506, 613 addition unit; 511 y-axis current control unit; 512 δ-axis current control unit; 611 proportional control unit; 612 integral control unit; 900 refrigeration cycle application apparatus; 901 compressor; 902 four-way valve; 904 compression mechanism; 906 indoor heat exchanger; 908 expansion valve; 910 outdoor heat exchanger; 912 refrigerant pipe; D1, D2, D3, D4 diode.

1. A power conversion apparatus that supplies alternating-current power to a motor, the motor driving a load, the power conversion apparatus comprising:
a converter rectifying a power-supply voltage applied from an alternating-current power supply;
a capacitor connected to an output end of the converter;
an inverter connected across the capacitor; and
a control device controlling an operation of the inverter, wherein
the control device performs a first control of reducing a pulsatile component of a capacitor output current output from the capacitor to the inverter when the load is driven,
the first control is control of causing the motor to generate a loss, and
the loss that the motor is caused to generate is performed by using an excitation current.

2. The power conversion apparatus according to claim 1, wherein
the control device causes the motor to generate a loss in a first period in which motor power that is power supplied from the inverter to the motor becomes smaller than a set power value.

3. The power conversion apparatus according to claim 2, wherein
the set power value is an average value of the motor power obtained when the first control is not performed.

4. The power conversion apparatus according to claim 2, wherein
the control device increases an absolute value of the excitation current in the first period.

5. The power conversion apparatus according to claim 4, wherein
a value of the excitation current is negative.

6. The power conversion apparatus according to claim 1, wherein
the control device includes:
a command value generation unit generating an excitation current command value based on a torque current or an excitation current; and
a current compensation unit generating a current compensation value for reduction of the pulsatile component, and
the current compensation value is superimposed on the excitation current command value.

7. A motor drive apparatus comprising the power conversion apparatus according to claim 1.

8. A refrigeration cycle application apparatus comprising the power conversion apparatus according to claim 1.
